(19) United States
(12) Patent Application Publication
(10) Pub. No.: US 2021/0360458 A1
(43) Pub. Date: Nov. 18, 2021

(54) USER EQUIPMENT FOR RSSI MEASUREMENT AND RSSI MEASUREMENT METHOD

(71) Applicant: MEDIATEK INC., Hsinchu City (TW)

(72) Inventors: Hsuan-Li LIN, Hsinchu City (TW); Tsang-Wei YU, Hsinchu City (TW)

(21) Appl. No.: 17/243,822

(22) Filed: Apr. 29, 2021

Related U.S. Application Data
(60) Provisional application No. 63/025,282, filed on May 15, 2020.
(60) Provisional application No. 63/025,277, filed on May 15, 2020.

(51) Int. Cl. H04W 24/10; H04B 17/318; H04L 5/00

(52) U.S. Cl. CPC H04W 24/10; H04L 5/0092; H04B 17/318

(57) ABSTRACT

User equipment (UE) for Received Signal Strength Indicator (RSSI) measurement is provided. The UE may include a radio frequency (RF) signal processing device and a processor. The RF signal processing device receives an RSSI measurement. The processor is coupled to the RF signal processing device. The processor determines whether the RSSI measurement is an intra-frequency RSSI measurement or an inter-frequency RSSI measurement based on the carrier bandwidth of the UE and a sub-band which is configured for the RSSI measurement.

### CROSS REFERENCE TO RELATED APPLICATIONS

This application claims priority of U.S. Provisional Patent Application No. 63/025,277, filed on May 15, 2020 and U.S. Provisional Patent Application No. 63/025,282, filed on May 15, 2020, the entirety of which is incorporated by reference herein.

### BACKGROUND OF THE INVENTION

### Field of the Invention

The invention generally relates to a wireless communication technology, and more particularly, to Received Signal Strength Indicator (RSSI) measurement technology.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In the 5G NR, Received Signal Strength Indicator (RSSI) is introduced as a loading measure. Therefore, the corresponding behaviors of the UE for the RSSI measurement need to be designed.

### BRIEF SUMMARY OF THE INVENTION

User equipment (UE) for Received Signal Strength Indicator (RSSI) measurement and an RSSI measurement method are provided to overcome the problems mentioned above.

An embodiment of the invention provides user equipment (UE) for Received Signal Strength Indicator (RSSI) measurement. The UE may comprise a radio frequency (RF) signal processing device and a processor. The RF signal processing device receives an RSSI measurement. The processor is coupled to the RF signal processing device. The processor determines whether the RSSI measurement is an intra-frequency RSSI measurement or an inter-frequency RSSI measurement based on the carrier bandwidth of the UE and a sub-band which is configured for the RSSI measurement.

In some embodiments of the invention, when the sub-band is fully contained in the carrier bandwidth of the UE, the processor determines that the RSSI measurement is the intra-frequency RSSI measurement.

In some embodiments of the invention, when the RSSI measurement is the intra-frequency RSSI measurement, the processor determines whether a measurement gap is needed for the RSSI measurement based on the active downlink (DL) bandwidth part (BWP) of the UE and the sub-band configured for the RSSI measurement.

In some embodiments of the invention, when the sub-band is fully within the active DL BWP, a measurement gap is not needed for the RSSI measurement. The measurement period for the measurement is determined based on a carrier-specific-sharing-factoroutside_gap (CSSFoutside_gap).

In some embodiments of the invention, when the sub-band partially overlaps or does not overlap the active DL BWP, a measurement gap is needed for the RSSI measurement. The measurement period for the measurement is determined based on a carrier-specific-sharing-factorwithin_gap (CSSFwithin_gap).

In some embodiments of the invention, when the sub-band is not fully contained within the carrier bandwidth, the processor determines that the RSSI measurement is the inter-frequency RSSI measurement. The measurement period for the measurement is determined based on a carrier-specific-sharing-factorwithin_gap (CSSFwithin_gap).

An embodiment of the invention provides a Received Signal Strength Indicator (RSSI) measurement method. The RSSI measurement method is applied to user equipment (UE). The RSSI measurement method comprises the following steps: receiving an RSSI measurement through a radio frequency (RF) signal processing device of the UE; and determining whether the RSSI measurement is an intra-frequency RSSI measurement or an inter-frequency RSSI measurement based on the carrier bandwidth of the UE and a sub-band which is configured for the RSSI measurement through a processor of the UE.

Other aspects and features of the invention will become apparent to those with ordinary skill in the art upon review of the following descriptions of specific embodiments of delay tracking method and the memory system.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2A is a schematic diagram of illustrating intra-frequency RSSI measurement without gap according to an embodiment of the invention.

FIG. 2B is a schematic diagram of illustrating intra-frequency RSSI measurement with gap according to another embodiment of the invention.

FIG. 2C is a schematic diagram of illustrating intra-frequency RSSI measurement with gap according to another embodiment of the invention.

FIG. 2D is a schematic diagram of illustrating inter-frequency RSSI measurement with gap according to an embodiment of the invention.

FIG. 2E is a schematic diagram of illustrating inter-frequency RSSI measurement with gap according to another embodiment of the invention.

FIG. 3 is a flow chart 300 illustrating an RSSI measurement method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

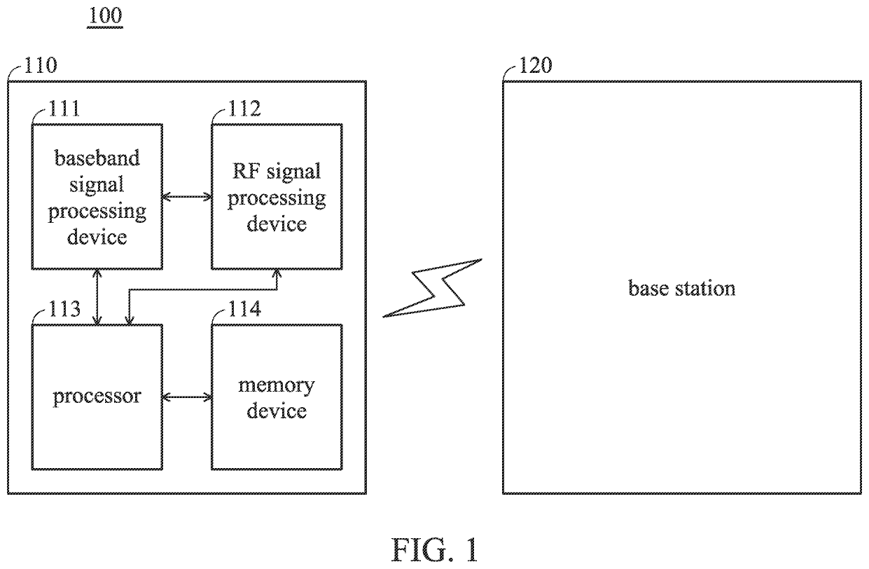

FIG. 1 is a block diagram of a wireless communications system 100 according to an embodiment of the invention. As shown in FIG. 1, the wireless communications system 100 may comprise user equipment (UE) 110 and a base station 120. It should be noted that in order to clarify the concept of the invention, FIG. 1 presents a simplified block diagram in which only the elements relevant to the invention are shown. However, the invention should not be limited to what is shown in FIG. 1.

As shown in FIG. 1, the UE 110 may comprise at least a baseband signal processing device 111, a radio frequency (RF) signal processing device 112, a processor 113, a memory device 114, and an antenna module comprising at least one antenna. It should be noted that in order to clarify the concept of the invention, the UE 110 of FIG. 1 presents a simplified block diagram in which only the elements relevant to the invention are shown. However, the invention should not be limited to what is shown in FIG. 1.

In the embodiments of the invention, the UE 110 may be a smartphone, Personal Data Assistant (PDA), pager, laptop computer, desktop computer, wireless handset, or any computing device that includes a wireless communications interface.

The RF signal processing device 112 may receive RF signals via the antenna and process the received RF signals to convert the received RF signals to baseband signals to be processed by the baseband signal processing device 111, or receive baseband signals from the baseband signal processing device 211 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, analog-to-digital converter (ADC)/digital-to-analog converter (DAC), etc.

The baseband signal processing device 111 may further process the baseband signals to obtain information or data transmitted by the peer communications apparatus. The baseband signal processing device 111 may also comprise a plurality of hardware elements to perform baseband signal processing.

The processor 113 may control the operations of the baseband signal processing device 111 and the RF signal processing device 112. According to an embodiment of the invention, the processor 113 may also be arranged to execute the program codes of the software module(s) of the corresponding baseband signal processing device 211 and/or the RF signal processing device 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software modules.

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

In the embodiments, The base station 120 may be a gNodeB (gNB), a NodeB (NB) an eNodeB (eNB), an access point, an access terminal, but the invention should not limited thereto. In the embodiments, the UE 110 may communicate with the base station through the fifth generation (5G) communication technology or 5G New Radio (NR) communication technology, but the invention should not be limited thereto.

In an embodiment of the invention, a RF signal processing device 112 may receive a Received Signal Strength Indicator (RSSI) measurement and the RSSI timing configuration (RMTC) from the base station 120. The RSSI measurement and the RMTC may be contained in the measurement object (MO) configured through the Radio Resource Control (RRC) configuration. In the embodiments of the invention, the RMTC may comprise an offset, a periodicity, a duration, and a Sub-Carrier spacing (SCS) which is used to calculate the duration. In an embodiment of the invention the SCS in the RMTC is the same as an active Bandwidth Part in the serving cell.

In an embodiment of the invention, when the UE 110 obtains the RSSI measurement, the processor 113 may determine that the RSSI measurement is an intra-frequency RSSI measurement or an inter-frequency RSSI measurement based on a carrier bandwidth (or channel band width) of the UE 110 and a sub-band which is configured for the RSSI measurement. In the embodiments of the in invention, the sub-band may be regarded as a listen-before-talk (LBT) sub-band or an RSSI (measurement) bandwidth (BW). Specifically, the processor 113 may determine whether the sub-band configured for the RSSI measurement is fully contained within the carrier bandwidth of the UE 110 to determine whether the RSSI measurement is an intra-frequency RSSI measurement or an inter-frequency RSSI measurement.

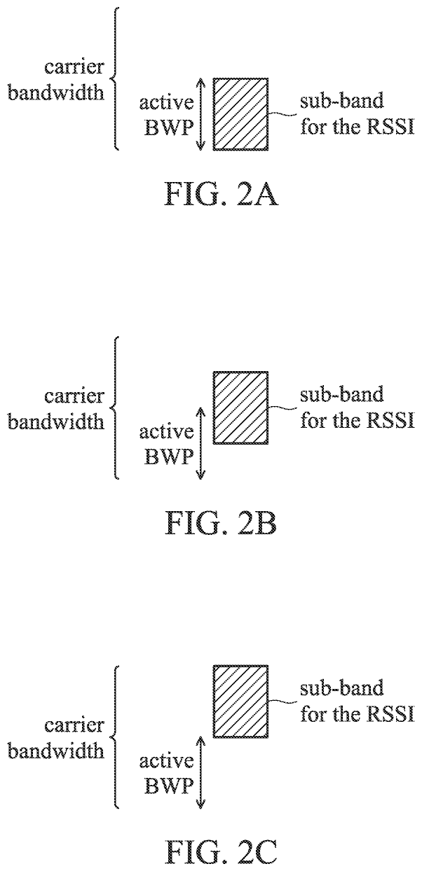

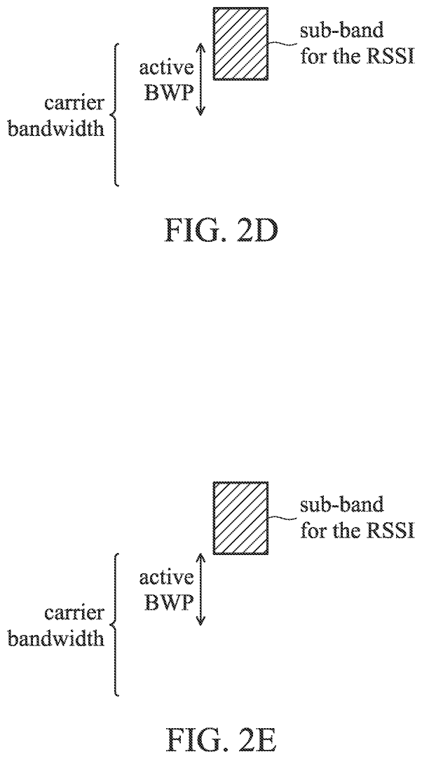

As shown in FIGS. 2A-2C, when the sub-band configured for the RSSI measurement is fully contained within the carrier bandwidth of the UE 110, the processor 113 may determine that the RSSI measurement is the intra-frequency RSSI measurement.

In an embodiment of the invention, when the RSSI measurement is the intra-frequency RSSI measurement, the processor 113 may further determine whether a measurement gap is needed for the RSSI measurement based on an active bandwidth part (BWP) (or active downlink (DL) BWP) of the UE 110 and the sub-band configured for the RSSI measurement. Specifically, the processor 113 may determine whether the sub-band configured for the RSSI measurement is fully within the active BWP of the UE 110.

As shown in FIG. 2A, when the sub-band for the RSSI measurement is fully within the active BWP of the UE 110, a measurement gap will not be needed for the RSSI measurement. In the case, a measurement period for the RSSI measurement will be determined based on a carrier-specific-sharing-factor_{outside_gap} (CSSF_{outside_gap}).

As shown in FIGS. 2B-2C, when the sub-band for the RSSI measurement partially overlaps or does not overlap the active BWP of the UE 110, a measurement gap will be needed for the RSSI measurement. In the case, the measurement period for the measurement will be determined based on a carrier-specific-sharing-factor_{within_gap} (CSSF_{within_gap}).

As shown in FIGS. 2D-2E, when the sub-band configured for the RSSI measurement is not fully contained within the carrier bandwidth of the UE 110 (i.e. the sub-band configured for the RSSI measurement partially overlaps the carrier bandwidth of the UE 110 or the sub-band configured for the RSSI measurement does not overlap the carrier bandwidth of the UE 110), the processor 113 may determine that the RSSI measurement is the inter-frequency RSSI measurement, wherein a measurement gap is needed in the inter-frequency RSSI measurement. In the case, the measurement period for the measurement will be determined based on a CSSF_{within_gap}.

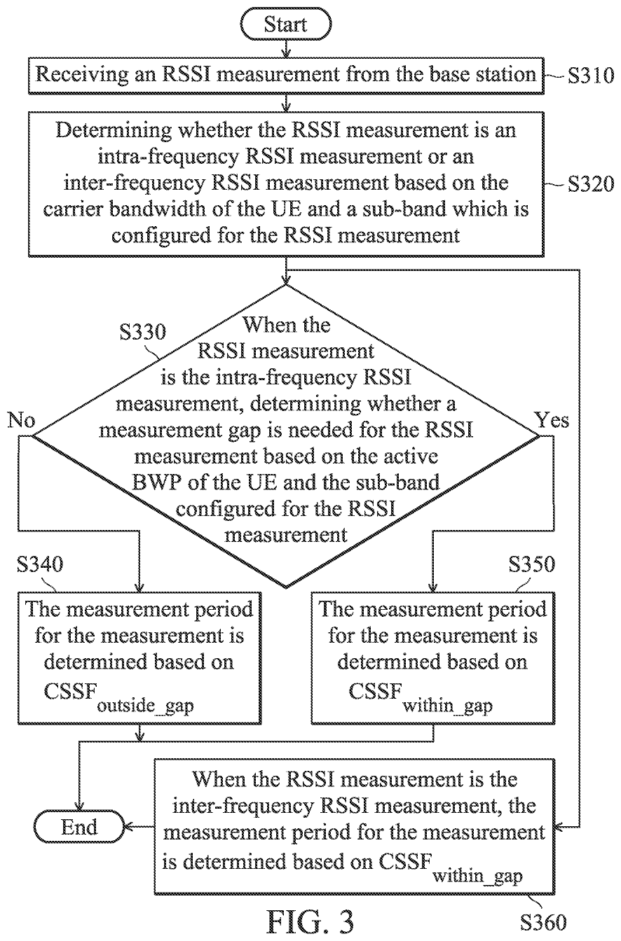

FIG. 3 is a flow chart 300 illustrating a Received Signal Strength Indicator (RSSI) measurement method according to an embodiment of the invention. The RSSI measurement method can be applied to the communication system 100 which comprises the UE 110 and the base station 120. As shown in FIG. 3, in step S310, the UE 110 may receive an RSSI measurement from the base station 120.

In step S320, the UE 110 may determine whether the RSSI measurement is an intra-frequency RSSI measurement or an inter-frequency RSSI measurement based on the carrier bandwidth of the UE 110 and a sub-band which is configured for the RSSI measurement. When the sub-band is fully contained within the carrier bandwidth, the UE 110 determines that the RSSI measurement is the intra-frequency RSSI measurement. When the sub-band is not fully contained within the carrier bandwidth, the UE 110 determines that the RSSI measurement is the inter-frequency RSSI measurement.

When the RSSI measurement is the intra-frequency RSSI measurement, step S330 is performed. In step S330, the UE 110 may determine whether a measurement gap is needed for the RSSI measurement based on the active bandwidth part (BWP) (or active downlink (DL) BWP) of the UE 110 and the sub-band configured for the RSSI measurement.

When the sub-band is fully within the active BWP of the UE 110, the UE 110 may determine that a measurement gap is not needed for the RSSI measurement. When the gap is not needed for the RSSI measurement, step S340 is performed. In step S340, the measurement period for the measurement is determined based on a carrier-specific-sharing-factor_{outside_gap} (CSSF_{outside_gap}).

When the sub-band partially overlaps or does not overlap the active BWP of the UE 110, the UE 110 may determine that a measurement gap is needed for the RSSI measurement. When the gap is needed for the RSSI measurement, step S350 is performed. In step S350, the measurement period for the measurement is determined based on a carrier-specific-sharing-factor_{within_gap} (CSSF_{within_gap}).

When the RSSI measurement is the inter-frequency RSSI measurement, step S360 is performed. In step S360, the measurement period for the measurement is determined based on a carrier-specific-sharing-factor_{within_gap} (CSSF_{within_gap}).

In the RSSI measurement method provided in the invention, the UE will be able to determine whether the RSSI measurement is an intra-frequency RSSI measurement or an inter-frequency RSSI measurement based on the carrier bandwidth of the UE and a sub-band which is configured for the RSSI measurement. In addition, in the RSSI measurement method provided in the invention, when the RSSI measurement is an intra-frequency RSSI measurement, the UE will be able to determine whether a measurement gap is needed for the RSSI measurement based on an active BWP of the UE 110 and the sub-band configured for the RSSI measurement.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A user equipment (UE) for Received Signal Strength Indicator (RSSI) measurement, comprising:
a radio frequency (RF) signal processing device, receiving an RSSI measurement; and
a processor, coupled to the RF signal processing device and determining whether the RSSI measurement is an intra-frequency RSSI measurement or an inter-frequency RSSI measurement based on a carrier bandwidth of the UE and a sub-band which is configured for the RSSI measurement.

2. The UE of claim 1, wherein when the sub-band is fully contained in the carrier bandwidth, the processor determines that the RSSI measurement is the intra-frequency RSSI measurement.

3. The UE of claim 2, wherein when the RSSI measurement is the intra-frequency RSSI measurement, the processor determines whether a measurement gap is needed for the RSSI measurement based on an active downlink (DL) bandwidth part (BWP) of the UE and the sub-band configured for the RSSI measurement.

4. The UE of claim 3, wherein when the sub-band is fully within the DL active BWP, the measurement gap is not needed for the RSSI measurement.

5. The UE of claim 4, wherein a measurement period for the measurement is determined based on a carrier-specific-sharing-factor_{outside_gap} (CSSF_{outside_gap}).

6. The UE of claim 3, wherein when the sub-band partially overlaps or does not overlap the active DL BWP, the measurement gap is needed for the RSSI measurement.

7. The UE of claim 6, wherein a measurement period for the measurement is determined based on a carrier-specific-sharing-factor_{within_gap} (CSSF_{within_gap}).

8. The UE of claim 1, wherein when the sub-band is not fully contained in the carrier bandwidth, the processor determines that the RSSI measurement is the inter-frequency RSSI measurement.

9. The UE of claim 8, wherein a measurement period for the measurement is determined based on a carrier-specific-sharing-factor_{within_gap} (CSSF_{within_gap}).

10. A Received Signal Strength Indicator (RSSI) measurement method, applied in user equipment (UE), comprising:
receiving, by a radio frequency (RF) signal processing device of the UE, an RSSI measurement; and
determining, by a processor of the UE, whether the RSSI measurement is an intra-frequency RSSI measurement or an inter-frequency RSSI measurement based on a carrier bandwidth of the UE and a sub-band which is configured for the RSSI measurement.

11. The RSSI measurement method of claim 10, further comprising:
when the sub-band is fully contained within the carrier bandwidth, determining, by the processor, that the RSSI measurement is the intra-frequency RSSI measurement.

12. The RSSI measurement method of claim 11, wherein when the RSSI measurement is the intra-frequency RSSI measurement, determining, by the processor, whether a measurement gap is needed for the RSSI measurement based on an active downlink (DL) bandwidth part (BWP) of the UE and the sub-band configured for the RSSI measurement.

13. The RSSI measurement method of claim 12, wherein when the sub-band is fully sub-band the active DL BWP, the measurement gap is not needed for the RSSI measurement.

14. The RSSI measurement method of claim 13, wherein a measurement period for the measurement is determined based on a carrier-specific-sharing-factor_{outside_gap} (CSSF_{outside_gap}).

15. The RSSI measurement method of claim 12, wherein when the sub-band partially overlaps or does not overlap the active DL BWP, the measurement gap is needed for the RSSI measurement.

16. The RSSI measurement method of claim 15, wherein a measurement period for the measurement is determined based on a carrier-specific-sharing-factor_{within_gap} (CSSF_{within_gap}).

17. The RSSI measurement method of claim 10, further comprising:
when the sub-band is not fully contained within the carrier bandwidth, determining, by the processor, that the RSSI measurement is the inter-frequency RSSI measurement.

18. The RSSI measurement method of claim 17, wherein a measurement period for the measurement is determined based on a carrier-specific-sharing-factor_{within_gap} (CSSF_{within_gap}).
